(19) United States
(12) Patent Application Publication
(10) Pub. No.: US 2024/0127376 A1
(43) Pub. Date: Apr. 18, 2024

(54) REAL PROPERTY TRANSACTIONS ON A PUBLIC LEDGER

(71) Applicant: Cole Asher Ratias, San Rafael, CA (US)

(72) Inventor: Cole Asher Ratias, San Rafael, CA (US)

(21) Appl. No.: 18/380,529

(22) Filed: Oct. 16, 2023

Related U.S. Application Data
(60) Provisional application No. 63/416,440, filed on Oct. 14, 2022.

(51) Int. Cl. G06Q 50/16; G06Q 20/02

(52) U.S. Cl. CPC G06Q 50/16; G06Q 20/02; G06Q 2220/00

(57) ABSTRACT

A system operating on a digital platform includes tokens of various types that represent and that record transactions on the digital platform. Each transaction, which may give rise to an enforceable right, is conducted and recorded on the digital platform by operation of a smart contract. Each token may represent an enforceable right, a currency unit, a fungible object or a non-fungible object. The enforceable right may be a tangible right of a real property or derived from a token based on the tangible property right.

### CROSS REFERENCE TO RELATED APPLICATIONS

This application is related to and claims priority of U.S. provisional application 63/416,440 filed on Oct. 14, 2022. The priority of this application is expressly claimed, and the disclosure is hereby incorporated by reference in their entirety.

### BACKGROUND OF THE INVENTION

### 1. Field of the Invention

This invention relates to conducting and recording transactions on a public ledger (e.g., a blockchain in a public computer network). In particular, the present invention relates to conducting and recording transactions relating to real property and digital rights derived therefrom on a public ledger.

### 2. Discussion of the Related Art

Ownership, possession, enjoyment and other legal rights appurtenant to real property (e.g., minerals and other resource rights, easements, and “rights-of-way”) are well-developed. As needs in human societies arise, new and valuable rights appurtenant to real property also appear in response. In recent times, architectural designs of buildings or other structures are given enforceable rights for limited times. Generally, the rights appurtenant to the real property have had physical manifestation. In the past, real property transactions—i.e., creations and conveyances of legal rights appurtenant to real property—are conducted and memorialized in written documents. Generally, enforcing such rights require the asserting party to prove its rights are valid, that it acquired its rights legally, and that it is in present possession of the asserted rights. Historically, the evidence required for the showing includes, for example, original or true copies of documents that create or convey the asserted rights, testimonies of witnesses and, in some jurisdictions, satisfaction of required procedures (e.g., recordation of the documents in the local recorder's office where the real property is located). Disputes—due to mistakes, malfeasance, and fraud—arise regularly throughout the history of real property transactions.

More recently, computer-based technological advances (e.g., virtual reality and augmented reality systems) give rise to even more possibilities of creating and conveying new legal rights that are appurtenant to real property (“digital real property rights”). In additional, the developments of public ledgers (e.g., blockchains) and smart contracts on computer networks provide vehicles (“digital platforms”) for conducting and recording business transactions that are persistent, fault-tolerant, and available for public scrutiny. A system that facilitates and handles all aspects of conventional and digital real property right transactions on digital platforms is desired.

### SUMMARY

A system operating on a digital platform comprising a plurality of tokens that embody transactions on the digital platform involving an enforceable right, a currency unit, a fungible object or a non-fungible object, wherein each transaction is conducted and recorded on the digital platform by operation of a smart contract, and wherein each token is either based on a tangible right appurtenant to a real property, a digital real property right created on the platform and made appurtenant to the real property, or derived from a token based on the tangible right or the digital real property.

The present invention is better understood upon consideration of the detailed description below and the accompanying drawings.

### DETAILED DESCRIPTION OF THE PREFERRED EMBODIMENTS

According to one embodiment of the present invention, systems and methods for establishing or claiming digital and other rights (e.g., conventional common law rights) appurtenant to or associates with real property are provided. Such systems and methods allow the owner of a real property to register or claim ownership to the rights, and to engage in transactions to exploit all aspects of the registered or claimed rights. In an exemplary system—including digital real property rights, self-executing transactions (“smart contracts”) concerning all aspects of creation, transfer, distribution and extinguishment of such digital property rights, and records thereof—may be created on a digital platform. The real digital property rights encompasses not only the physical or tangible aspects of the real property concerned, but also its use and likeness. In this detailed description, for brevity, the components of this exemplary system are collectively referred to as the “OpenHouse Protocol.” In addition to conventional real property rights, the digital property rights may be related to, for example, virtual objects and experiences that are appurtenant to an underlying a physical location or structure (i.e., a real property).

The OpenHouse Protocol facilitates creation of new digital real property rights that are appurtenant to a physical location or structure. In previous virtual reality systems, virtual objects akin to real estate or real-world objects have had value attempted to be assigned to such objects. The Openhouse Protocol reverses the conventional approach and starts with the real-world object. For example, various rights appurtenant to a real property—such as mineral rights—have value in the real-world. Within the Openhouse Protocol, each real property is embodied in a virtual object “Master Token”) that represent and holds the entirety of the rights appurtenant to the real estate parcel in the real world. The OpenHouse Protocol provides for transactions relating to both the conventional “real-world” assets (e.g., fee simple, easements, and mineral rights) appurtenant to the real property and also provide for transactions related to digital rights and other rights appurtenant to the real property. Such other rights include rights to virtual objects created in connection with the real property. The Openhouse Protocol then provides smart contracts and other systems to enable the owner of the real estate to manage and exploit the value of those rights. For example, a developer of a virtual reality, a digital twin of San Francisco, may use the Openhouse Protocol to contract with an owner of a real property within San Francisco to license the right to place advertising on the virtual, digital twin real property. In addition, digital real property rights may be associated with virtual objects created under the OpenHouse protocol, such as likeness and digital representation of objects or design elements, facility data (e.g., smart meter data), location and orientation of the real property (e.g., location relative to other geographic landmarks), 3-dimensional maps, point clouds, miniaturization, “doll house” representation, floor plan, architecture, colors, textures, safety inspection records, building codes compliance records, materials lists, construction specifications, fit and finish specifications, and any data derived therefrom. Such digital real property rights may even include other creative subject matters appurtenant to the real property (e.g., television presentations, music and animations). Smart contracts may be used to manage royalties (e.g., writer and producer credits) and their collections. The digital real property rights may be conventional intellectual property rights, or new types of rights that may arise by contract or by judicial or legislative processes (e.g., statutorily). Any digital real property right created under the OpenHouse Protocol may be embodied in an NFT-type “OpenHouse Token.” To protect the value of these creations, the OpenHouse Protocol includes protective measures to strictly enforce data integrity. The OpenHouse Protocol may include provisions for sale of title insurance both traditional and title insurance for newly recognized or less traditional property rights, such as digital real property rights and any other relevant digital rights.

As another example, using virtual reality techniques and the OpenHouse Protocol, one may create virtual experiences and virtual objects that are appurtenant to the real property. For example, a celebrity may create a virtual reality game based on the interior design and furniture of the celebrity's luxurious penthouse apartment overlooking Central Park, hosted by avatars of the celebrity and his family Such virtual experience may be encapsulated in a NFT-type OpenHouse Token under the OpenHouse Protocol. The virtual experience may be served, for example, through a smart contract executing under the OpenHouse Protocol, which allows the participants to enjoy the virtual experience in exchange for a payment to a sponsor (e.g., the celebrity herself) in an accepted currency (e.g., a crypto-currency, or a fungible OpenHouse Token, Bitcoins, Ethers,” or any suitable currency). Note that, in this detailed description, currency is medium of exchange, and is more conveniently provided in a digital system (e.g., one that is based on blockchains) as fungible tokens. A virtual shop may offer for sale or licensing additional digital property rights, such as floor plan, 3-dimensional map of the interior space, furniture and other internal objects. Unlike a currency, digital real property rights are typically non-fungible, and thus may be created and transferred as virtual objects (e.g., as non-fungible tokens (“NFTs”)). New digital property rights may be derived from existing digital property rights. The smart contract may also allow the participants of a virtual experience to customize the virtual experience to their preferences, such as identities of their avatar and their preferred company, and to save the state of the virtual experience for resumption at a later time,

Property owners may grant a visitor any digital real property right appurtenant to the property. For example, under the OpenHouse Protocol, a visitor to a friend's real property may activate security cameras or sensors, which gather data about the visitor (e.g., the visitor's movements, gait, mannerism, likeness, such as facial features, and any detected devices on the visitor's person). The captured data during the visit may be securely recorded under the OpenHouse Protocol (e.g., in encrypted form, and encapsulated in one or more NFT-type OpenHouse Token to be associated with the Master Token on the blockchain). Any digital real property right associated with the OpenHouse Token, and all data embodied in that OpenHouse Token are created through a smart contract associated with the Master Token under the OpenHouse Protocol. Subsequent access to the visitor's data and associated digital rights embodied in the OpenHouse Token may be requested under the OpenHouse Protocol. Access controls to the OpenHouse Token may be strictly enforced through the Openhouse Protocol. In addition, obligations and privileges associated with OpenHouse Token between the owner and the visitor may be enforced by the OpenHouse Protocol between the owner and the visitor.

In another embodiment of the OpenHouse Protocol, all or a substantial portion of transactions or data are recorded on the public ledger (e.g., a blockchain or any relevant technology suitable for implementing a secure public ledger). In this embodiment, the transparency, precision in time, and security of the technology that implement the public ledger ensure integrity and precise ordering of the recorded transactions, and thereby guard against unauthorized data manipulation or association. In another embodiment, the OpenHouse Protocol ensures fair community distribution—i.e., the OpenHouse Protocol enforces a rule such that no participant can acquire an outsized position, either in equity or control, in the community (“Openhouse Community.”

In one embodiment, Openhouse Tokens conform to a Ethereum multi-token standard (e.g., EIP-1155) and thus are generally backward compatible with both fungible tokens (e.g., those under EIP-20) and non-fungible tokens (e.g., ETH-721). A transaction involving an OpenHouse Token is associated with a smart contracts under the OpenHouse Protocol. The smart contract may be provided using any suitable programming language (e.g., Solidity, or any programming language accepted by suitable blockchain-based system, colloquially referred to as “blockchain oracles”). As a digital real property right is appurtenant to a real property, the OpenHouse Protocol strictly enforces conventional real property rights (“tangible rights”) in the derivative digital property rights and virtual objects. Examples of tangible rights include fee simple, life tenancy, leasehold, joint tenancy, tenants-in-common, right of survivorship, and combinations thereof. For example, creation of a digital real property right may be constrained by existing tangible rights: digital real property rights to the water resources, and their derivatives, may not exceed the tangible rights to the water resources on the real property it is based. For such control, the OpenHouse Protocol scrutinizes transactions involving an Openhouse Token, including its creation. For example, for compliance with the OpenHouse Protocol, a participant may have to remove data—or data models trained with such data—associated with a proposed OpenHouse Token. The participant may also have to ensure requirements imposed by the implementing system (e.g., storage system and any conditions imposed by a supplier, such as a software developer kits (“SDK”)).

By enforcing conformance to the tangible rights, the OpenHouse protocol ensures integrity in digital real property rights in the system, which facilitates transactions and enhances desirability to participants. Because of the precision and the efficiency of smart contracts, disputes over transactions involving digital real property rights are expected to be extremely rare. On such rare occasions, the integrity in the OpenHouse Protocol may facilitate enforcement by real life authorities. Integrity of the OpenHouse Protocol inspires confidence in the OpenHouse Tokens or NFTs, which enhances their acceptability and desirability, leading to greater usage, circulation and even financial value.

Beyond the tangible right constraints, however, the OpenHouse Protocol provide great flexibility in creating digital real property rights. Creation and subsequent transaction of the digital real property rights, as OpenHouse Tokens, are easily recorded, conducted and tracked on a digital platform under the OpenHouse Protocol. Referring back to the virtual experience described above, for example, a participant who created a virtual object based on a distinctive feature of the real property may license the use of the virtual object to a commercial entity (e.g., a branded coffee cup bearing the likeness of the virtual object). (The distinctive feature itself may be an existing digital real property right embodied in an OpenHouse Token, for example.) This is one example by which the OpenHouse Protocol allows significant financial value to be derived from digital real property rights. The license—itself an OpenHouse Token, for example—may be tracked and enforced in a smart contract for its use in real or virtual environments, such that the grantor of the license may enjoy the tax rights in the license. Again, for integrity reasons, the OpenHouse protocol may enforce rules related to the OpenHouse Tokens. Participants, including financial entities, are required to comply with existing laws and regulations and agree with remedial actions. Remedial actions the OpenHouse Protocol may conduct includes, for example, voiding of payments, restrictions and suspensions of participant privileges, and garnishments of receipts from the offending participant.

In one embodiment, under the OpenHouse Protocol, an owner of a real property may allow third-party (e.g., an artist) to associate their work (e.g., a digital “oil” painting) with a portion of a real or virtual portion of the real property, and to allow others to access and view the third-party's work. The OpenHouse Protocol may also allow an owner of a real property to police unauthorized derivative work based on the real property on the digital platform. For example, a participant may not set up an unauthorized paid or free tour of the Empire State Building. The digital platform may provide rules and means under the OpenHouse Protocol to compel participants on the digital platform to legitimize or remove the unauthorized derivative work. The OpenHouse Protocol may also arbitrate among multiple participants to determine who among them is the first to create a specific type of derivative work (e.g., first to associate a particular landmark under license to their goods or services). The owner of the derivative work may also be accorded and allowed to enforce under the OpenHouse Protocol appropriate digital real property rights, subject to other superior digital real property rights, appurtenant to the real property.

Therefore, through smart contracts and OpenHouse Tokens, the OpenHouse Protocol operating on a digital platform provides an efficient mechanism for creating, recording, tracking and enforcing digital real property rights and associated tangible rights. As transactions on a digital platform, once accepted, are unambiguously time-stamped, digital real property rights, a system under the OpenHouse Protocol supports horizontal scaling, so that multiple generators of the digital real property rights may synchronize among themselves, and allow cross-references of each other's transactions.

In one embodiment, the Openhouse Protocol may pre-mint a predetermined number of OpenHouse Tokens (e.g., 20 billion) to be associated each unit of real property (e.g., a parcel or per square meter). Based on these pre-minted OpenHouse Token, an owner may create digital real property rights by minting derivative OpenHouse Tokens (e.g., as an NFT-type OpenHouse Token). The OpenHouse Protocol therefore provide a simple digital marketplace for tangible assets and digital real property rights. (At this time, of course, any transfer of tangible rights need to comply with requirements of the associated authorities, in addition to compliance with the OpenHouse Protocol.)

The OpenHouse Protocol requires the participants to comply with all relevant legal obligations. For example, a participant must acknowledge and certify its compliance with any legal obligation to which its proposed OpenHouse Token to be minted may be subject. For example, a virtual object that is subject to another's copyright royalties must acknowledge and certify compliance with the obligation. The OpenHouse Protocol may require reservation of financial resources (e.g., a certain percentage from the proceeds of minting the proposed OpenHouse Token) should remedial actions be necessary. The OpenHouse Protocol may also require the participant to take collateralize against certain potential liabilities.

The inherent integrity of the OpenHouse Protocol allows participants to underwrite an insurance policy (again as an OpenHouse Token associated with a smart contract), including title insurance, to transactions under the OpenHouse Protocol, assuring performance of any obligation involving any tangible right or digital real property right, such as those embodied in an OpenHouse Token. Of course, a participant underwriting an insurance policy must provide reserve as collateral to guarantee performance. The OpenHouse community may establish adequacy requirements for such collateral. The associated smart contract associated with the insurance policy may alert or flag any suspicious transaction involving the tangible or digital real property right appurtenant to the insurance policy, and may assist relevant authorities (e.g., a law enforcement authority or a crypto-exchange) by providing access to relevant data.

The efficiency of smart contracts under the OpenHouse Protocol enables highly efficient transactions, such as renegotiation for immediate extensions of existing licenses. Alternatively, any digital real property right may be revoked, restricted or suspended instantly upon a determination of non-performance by the smart contract. Such suspension of right may affect transactions outside the OpenHouse community. For example, the smart contract may suspend access data to an external resource, such as access to an external data source linked by an application programming interface (API) to the smart contract. It is envisioned that the integrity of the services under the OpenHouse Protocol allows it to replace the evidentiary roles traditionally played by county recorders' offices.

The OpenHouse Protocol facilitates creation of financial transactions that are collateralized by tangible rights or digital real property rights. Because of the inherent integrity of the OpenHouse Protocol, smart contracts under the OpenHouse protocol provide great flexibility and benefits in creating digital financial instruments that can be easily policed and enforced. For example, as digital real property rights are constrained by the underlying tangible rights, a mortgage or lien on a tangible right or a digital real property right can be created only to the extent free of encumbrance in all underlying relevant tangible rights and relevant digital real property rights. The smart contract associated with the digital financial instrument created under the OpenHouse Protocol may include provisions that police changes in any relevant encumbrance, so as to trigger a default condition should a violation be detected. Of course, the value of a digital property right generally represents the intellectual property that created above and beyond the underlying tangible rights, so that a financial instrument appurtenant the value of the intellectual property provides significant benefits to the creator of the intellectual property.

In some embodiments, through smart contracts under the OpenHouse Protocol, a local government, for example, may collect real estate taxes and mandate building code inspections (e.g., for safety and structural integrity) and take enforcement actions. For example, any code violations uncovered in a physical inspection may be recorded in the digital platform, and not cleared until the owner records certified remedial actions any pays any applicable penalties.

Sensors (e.g., smoke alarms) may be coupled to smart contracts under the OpenHouse protocol and policed in real time through the smart contracts. Likewise, energy use and climate control sensors and actuators may also be managed under the OpenHouse Protocol. Fixtures (e.g., WiFi or communication equipment and 3-D printers) may also be likewise managed by smart contracts under the OpenHouse Protocol. For example, metered use of such fixtures by visitors may be enforced by the smart contract.

The virtual experience example described above represents one of many types of potential commercial opportunities. The OpenHouse community may establish rewards (e.g., awards of OpenHouse Tokens) for developing new virtual experiences or virtual objects under the OpenHouse Protocol. Similarly, incentives may be provided for staking of OpenHouse Tokens, referring participants who brings in other eligible participants (e.g., owners of real property who may tokenize their tangible rights in the real property), create games based on tangible and digital real property rights, or create new types of digital property rights, especially those incorporating virtual reality elements.

An OpenHouse Token may also represent an access right to a resource, such as access to a portal that provides data services related to tangible rights or digital real property rights within and outside of the OpenHouse community. Access and enjoyment to the real property (e.g., various types of tenancies, custodianships, and leases) may also be created, monitored and controlled under the OpenHouse Protocol. For example, a smart contract may grant access and may manage access by a qualified visitor or tenant. Biometric sensors and access control servers, for example, may be managed by smart contracts under the OpenHouse Protocol. The smart contract may record any data related to the use by the visitor, custodian or tenant, with appropriate protection for confidentiality, and their personal and privacy rights.

The smart contract over multiple real properties may manage access privileges accorded the visitor, custodian or tenant to the multiple real properties. The rights accorded to the visitor may be different for each associated real property. Digital real property tights created or earned by the visitor, custodian or tenant may also be created, recorded and managed on the digital platform.

In some embodiment, an owner of a real property may establish an exclusive authority (e.g., an oracle) under the OpenHouse Protocol to handle access to and admission of any transactions related to the real property on the digital platform. In that regard, for example, when a smart contract under the OpenHouse Protocol requires a participant to take action, the authority may compel the participant's local system to comply with its requirements before action can be taken (e.g., the software used to take actions are qualified and its access legitimately acquired). The authority may impose penalties and taxes on violators. Penalties may include, for example, rate limits to access or store data, delayed feature access, delayed priority processing, reduced bandwidth, temporary suspension, and permanent suspension. The authority may also exercise lesser control, such as merely monitoring and enforcing integrity of transactions carried out by authorized participants. Appropriate penalties may be imposed on violators (e.g., reduced access privileges and reduced quality of service—such as response times), depending on the severity, repetitiveness and frequency of violations.

The detailed description above is provided to illustrate specific embodiments of the present invention and is not intended to be limiting. Numerous variations and modifications within the scope of the present invention are possible. The present invention is set forth in the following accompanying claims.

I claim:

1. A system operating on a digital platform comprising a plurality of tokens that embody transactions on the digital platform involving an enforceable right, a currency unit, a fungible object or a non-fungible object, wherein each transaction is conducted and recorded on the digital platform by operation of a smart contract, and wherein each token is either based on a tangible right appurtenant to a real property, a digital real property right created on the platform and made appurtenant to the real property, or derived from a token based on the tangible right or the digital real property.

2. The system of claim 1, wherein the tangible right comprises one or more of: fee simple, life tenancy, leasehold, joint tenancy, tenants-in-common, right of survivorship, and combinations thereof.

3. The system of claim 1, wherein the digital real property right comprises intellectual property rights related to a virtual object created on the digital platform and made appurtenant to the real property.

4. The system of claim 1, wherein the digital platform comprises a public ledger on a computer network.

5. The system of claim 4, wherein the digital ledger comprises a blockchain.

6. The system of claim 1, wherein the tokens comprise both fungible and non-fungible tokens.

7. The system of claim 1, wherein the tokens further comprise embodiment of a virtual experience.

8. The system of claim 7, wherein the virtual experience is delivered by execution of a computer program running on the digital platform.

9. The system of claim 1, wherein the tokens further comprise a license to a tangible right or a digital real property right enforced by a smart contract.

10. The system of claim 9, wherein a smart contract handles extension, termination, assignment, transfer, or modification of the license.

11. The system of claim 1, wherein the token further comprises a financial instrument.

12. The system of claim 11, wherein the financial instrument comprises an insurance policy.

13. The system of claim 12, wherein the financial instrument comprises a collateralized debt instrument.

14. The system of claim 1, wherein one or more of the smart contracts enforce an obligation that arose when one token is derived from another token.

15. The system of claim 14 wherein, when the obligation is not performed, the derived token is subject to one or more of: revocation, restriction, or suspension of one or more privileges.

16. The system of claim 15, wherein the privileges comprise data access to an external resource.

17. The system of claim 14 wherein the smart contracts police changes in any relevant encumbrance on the real property, so as to trigger a default condition should a violation be detected.

18. The system of claim 14, wherein the obligation pertains to rewards to be awarded under a loyalty program.
